(19) United States
(12) Patent Application Publication
(10) Pub. No.: US 2014/0004785 A1
(43) Pub. Date: Jan. 2, 2014

(54) CONTAINER DATA CENTER

(71) Applicant: CHAO-KE WEI, Tu-Cheng (TW)

(72) Inventor: CHAO-KE WEI, Tu-Cheng (TW)

(73) Assignee: HON HAI PRECISION INDUSTRY CO., LTD., Tu-Cheng (TW)

(21) Appl. No.: 13/553,838

(22) Filed: Jul. 20, 2012

(30) Foreign Application Priority Data
Jun. 28, 2012 (TW) 101123161

(51) Int. Cl. F24F 13/28; B08B 1/00; F24F 7/06

(52) U.S. Cl. 454/253; 454/254; 15/77

(57) ABSTRACT

A container date center includes a container and an automatic dustproof device. The container defines an air inlet. A dustproof mesh covers the air inlet. The automatic dustproof device includes a brush slidably abutting against the dustproof mesh, a drive apparatus driving the bush to move relative to the dustproof mesh, a wind speed sensor installed in the container and aligning with the air inlet, a controller controlling the drive apparatus, and a computer electronically connected to the wind speed sensor and the controller. A measured value of the wind speed sensor is compared with a predetermined value stored in the computer. The controller controls the drive apparatus to operate in response to the measured value being less than the predetermined value.

### BACKGROUND

1. Technical Field

The present disclosure relates to a container data center.

2. Description of Related Art

Container data centers are centralized computing facilities. Each container data center includes a container, and a number of information processing devices installed in the container. During operation, the information processing devices generate a lot of heat in the container, and a common method for dissipating the heat involves using air conditioners, defining an air inlet in the container, and mounting a plurality of fans in the container. Dust can go through the air inlet and accumulate in the container, which may lead to components in the container breaking down. Thus, a dustproof mesh is installed in the air inlet. From time to time, the dustproof mesh needs to be disassembled from the container to be cleaned. However, it is time-consuming to do the cleaning job.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a cross-sectional view of an exemplary embodiment of a container data center, wherein the container data center includes an automatic dustproof device.

FIG. 2 is an enlarged, cross-sectional view of the automatic dustproof device of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

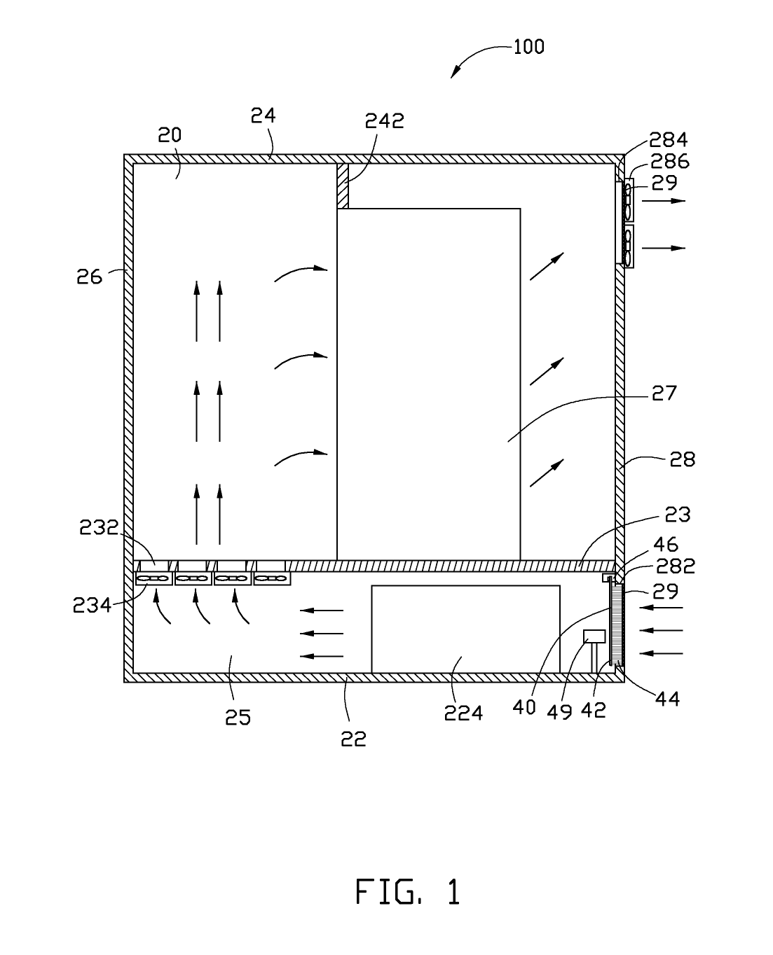

FIG. 1, illustrates an exemplary embodiment of a container data center 100. The container data center 100 includes a container 20 and an automatic dustproof device 40.

The container 20 includes a bottom wall 22, a top wall 24, a first sidewall 26 connected between first ends of the bottom wall 22 and the top wall 24. A second sidewall 28 connected between second ends of the bottom wall 22 and the top wall 24 opposite to the first sidewall 26. In addition, a support wall 23 connected between the first and second sidewalls 26 and 28 and above the bottom wall 22. A space 25 is defined between the support wall 23 and the bottom wall 22. A plurality of cabinets 27 is supported on the support wall 23. The support wall 23 defines a vent area 232 adjacent to the first sidewall 26. The space 25 communicates with an inner space of the container 20 through the vent area 232. A plurality of fans 234 is mounted to a bottom surface of the support wall 23, aligning with the vent area 232. The second sidewall 28 defines a rectangular air inlet 282 below the support wall 23, and an air outlet 284 adjacent to the top wall 24. Two dustproof meshes 29 are respectively installed to the second sidewall 28 and cover the air inlet 282 and the air outlet 284. A dehumidification and refrigeration apparatus 224 is installed on the bottom wall 22, between the air inlet 282 and the vent area 232. A plurality of exhaust fans 286 is installed to an outer surface of the second sidewall 28, aligning with the air outlet 284. A partitioning piece 242 is installed between the top wall 24 of the container 20 and tops of the cabinets 27 for avoiding thermal reflux. The automatic dustproof device 40 is installed to the second sidewall 28, adjacent to the air inlet 282.

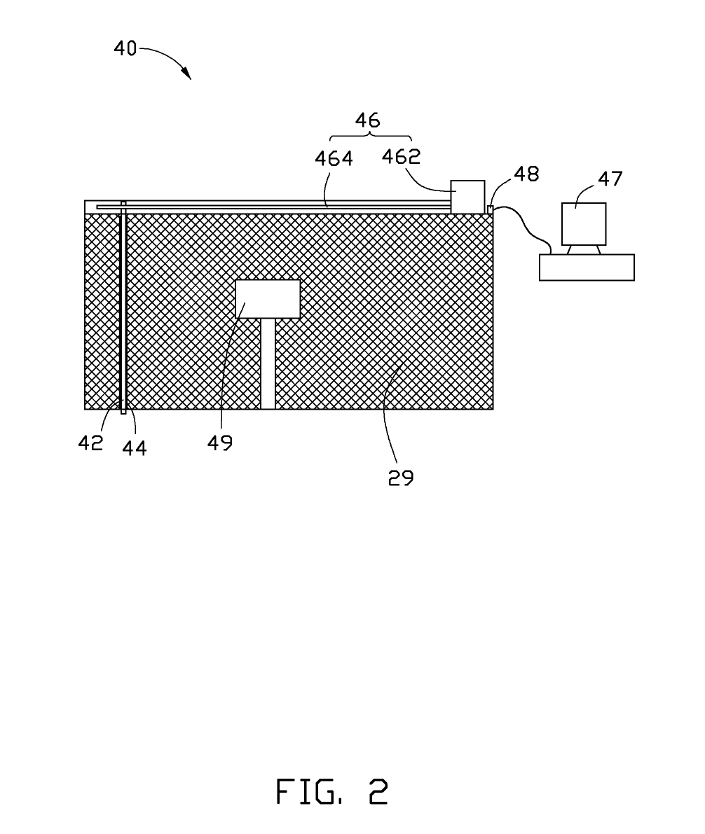

FIG. 2, illustrates the automatic dustproof device 40 of the embodiment. The automatic dustproof device 40 includes a slide pole 42, a brush 44 attached to the slide pole 42, a drive apparatus 46, a computer 47, a controller 48 electrically connected to the computer 47, and a wind speed sensor 49.

Two ends of the slide pole 42 are movably installed to the inner surface of the second sidewall 28, respectively at two opposite sides of the air inlet 282. The brush 44 movably abuts against an inner surface of the dustproof mesh 29. The drive apparatus 46 includes a motor 462 attached to the second sidewall 28 and a transmission belt 464 connected to the motor 462. One of the ends of the slide pole 42 is fixed to the transmission belt 464. The motor 462 can drive the slide pole 42 to slide relative to the dustproof mesh 29 through the transmission belt 464, in an extension direction of the transmission belt 464. The wind speed sensor 49 is installed on the bottom wall 22 and aligns with the air inlet 282, for measuring the velocity of an airflow flowing through the air inlet 282 and the dustproof mesh 29 and generated through the fans 234. A measured value of the wind speed sensor 49 is transmitted to the computer 47. The measured value of the wind speed sensor 49 is compared with a predetermined value stored in the computer 47. The controller 48 controls the drive apparatus 46 to drive the brush 44 operate in response to the measured value being less than the predetermined value.

In use, the fans 234 operate and draw airflow from the air inlet 282. The airflow flows through the dustproof mesh 29 and the dehumidification and refrigeration apparatus 224, to enter the support wall 23 through the vent area 232. The airflow, carrying heat generated by the cabinets 27, is dissipated out of the container 20 from the air outlet 284 through the exhaust fans 286. The dehumidification and refrigeration apparatus 224 can be used to cool and dry the airflow from the air inlet 282. The wind speed sensor 49 measures the velocity of the airflow, and transmits the measured value of the velocity of the airflow to the computer 47. The measured value of the velocity is compared with the predetermined value of the computer 47. If the measured value is less than the predetermined value, the controller 48 controls the motor 462 to operate. A combination of the slide pole 42 and the brush 44 is slid relative to the dustproof mesh 29 through the transmission belt 464, thus, the dust is removed from the dustproof mesh 29, until the measured value is greater than or equal to the predetermined value.

In another embodiment, another automatic dustproof device 40 is installed in the air outlet 284 of the second sidewall 28.

It is to be understood, however, that even though numerous characteristics and advantages of certain embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A container data center, comprising:
a container defining an air inlet;
a dustproof mesh covering the air inlet; and
an automatic dustproof device comprising a controller storing a predetermined speed value, a drive apparatus connected to the controller, a brush connected to the drive apparatus, and a wind speed sensor installed in the container and aligning with the air inlet, the brush slidably abutting against the dustproof mesh, wherein the controller controls the drive apparatus to drive the brush to brush the dustproof mesh, in response to a measured speed value from the wind speed sensor being less than the predetermined speed value.

2. The container data center of claim 1, wherein the container comprises a bottom wall, a top wall, a first sidewall connected between the bottom wall and the top wall, a second sidewall opposite to the first sidewall and connected between the bottom wall and the top wall, and a support wall connected between the first and second sidewalls and above the bottom wall, the air inlet is defined in the second sidewall, below the support wall.

3. The container data center of claim 2, wherein the automatic dustproof device further comprises a slide pole, two ends of the slide pole are movably installed to the second sidewall at two opposite sides of the air inlet, the bush is attached to the slide pole and abuts against an inner surface of the dustproof mesh.

4. The container data center of claim 3, wherein the drive apparatus comprises a motor connected to the controller and attached to the container, and a transmission belt connected to the motor, one of the ends of the slide pole is fixed to the transmission belt.

5. The container data center of claim 2, wherein the container further comprises a cabinet supported on the support wall, a vent area is defined in the support wall adjacent to the first sidewall, a plurality of fans is mounted to the supported wall and aligns with the vent area, the second sidewall defines an air outlet adjacent to the top wall, an exhaust fan is installed to the second sidewall at the air outlet.

6. The container data center of claim 5, wherein a partitioning piece is installed between the top wall of the container and a top of the cabinet.

7. The container data center of claim 6, wherein a dehumidification and refrigeration apparatus is installed on the bottom wall, between the air inlet and the vent area.
